(19) United States
(12) Patent Application Publication
(10) Pub. No.: US 2006/0216468 A1
(43) Pub. Date: Sep. 28, 2006

(54) Floor mat for automobile and manufacturing method therefor

(76) Inventor: Hong Ki Jeon, Seoul (KR)

Correspondence Address: PARK LAW FIRM, 3255 WILSHIRE BLVD, SUITE 1110, LOS ANGELES, CA, 90010, US

(21) Appl. No.: 11/085,484

(22) Filed: Mar. 22, 2005

(51) Int. Cl. B32B 7/00

(52) U.S. Cl. 428/119

(57) ABSTRACT

A floor mat for an automobile and manufacturing method therefor is provided. The automobile floor mat is laid on the indoor floor of the automobile in order to protect the indoor floor of the automobile, in which sill skirts and skid-proof bosses are formed in the mat more precisely and smoothly. Accordingly, value of commodities and reliability of the mat can be enhanced.

### BACKGROUND OF THE INVENTION

1. Field of the Invention

The present invention relates to a floor mat for an automobile and a manufacturing method therefor, and more particularly, to an automobile floor mat which is laid on the indoor floor of the automobile in order to protect the indoor floor of the automobile, in which sill skirts and skid-proof bosses are formed in the mat more precisely and smoothly, to accordingly enhance value of commodities and reliability of the mat, and a manufacturing method therefor.

2. Description of the Related Art

In general, an automobile floor mat is laid on an automobile indoor floor in order to prevent the indoor floor from being polluted or soiled due to soil or dust. In the case of an automobile floor mat 10 shown in FIG. 1, skid-proof bosses 12 are integrally formed and protruded on the bottom of a pad 11 made of soft PVC (polyvinyl chloride) or raw rubber (hereinafter referred to as a molding material). Sill skirts 13 each having a certain width and height are formed along the edge of the pad 11. A carpet (not shown) made of soft cilia may be integrally combined with the upper surface of the pad 11.

The pad 11, the skid-proof bosses 12, and the sill skirts 13 which are formed in the automobile floor mat 10 are integrally, simultaneously formed with a mat manufacturing mold 20 which is shown in FIGS. 2 and 3.

The conventional mat manufacturing mold 20 which is used to manufacture the automobile floor mat 10 includes a lower mold 21 which has a pad forming hole 21a, boss forming holes 21b, and sill skirt forming protrusions 21c which are shaped in the upper portion thereof in correspondence to the pad 11, the bosses 12 and the sill skirts 13 of the mat 10, respectively, and an upper mold 22 which pressurizes a molding material injected into the lower mold 21 and fills into the pad forming hole 21a and the boss forming holes 21b, and has sill skirt forming grooves 22a corresponding to the sill skirt forming protrusions 21c of the lower mold 21 as well. Air vent holes 21d are formed in the sill skirt forming protrusions 21c of the lower mold 21 so that air remaining in the pad forming hole 21a and the boss forming holes 21b of the lower mold 21 or gas generated from the molding material can be discharged out in the case that the lower mold 21 and the upper mold 22 are combined with each other.

That is, the air vent holes 21d for discharging the inner air of the lower mold 21 and the gas generated from the molding material are formed in the sill skirt forming protrusions 21c of the lower mold 21 in the case of the conventional mat manufacturing mold 20 having the above-described structure. Accordingly, in the case that a molding material is injected, heated, pressurized and cooled between the lower mold 21 and the upper mold 22, in order to manufacture an automobile floor mat 10, the molding material is filled and cooled into the air vent holes 21d formed in the sill skirt forming protrusions 21c of the lower mold 21. As a result, partitioning marks 14 as shown in FIG. 1 are unnecessarily formed in the sill skirts 13 of the pad 11 formed in the automobile floor mat 10 which is manufactured by the conventional mat manufacturing mold 20 in the form of the air vent holes 21d of the lower mold 21.

In addition, the boss forming holes 21b are engraved in intaglio on the bottom of the pad forming hole 21a in the case of the conventional automobile floor mat manufacturing mold 20. Accordingly, in the case that a molding material such as PVC or raw rubber is injected into the pad forming hole 21a and the boss forming holes 21b formed in the mat manufacturing mold in order to form the pad 11 and the bosses 12 in the mat 10, air remaining in the boss forming holes 21b of the mold and gas generated from the molding material are not completely discharged out but remains in the boss forming holes 21b. As a result, the molding material is not accurately filled into the boss forming holes 21b of the mold, and so the tips of the formed bosses 12 are rounded.

### SUMMARY OF THE INVENTION

To solve the above problems, it is an object of the present invention to provide an automobile floor mat and a manufacturing method therefor in which sill skirts formed along the edge of a pad thereof are smoothly formed so as to have a certain width and height without leaving partitioning marks on the mat as in the conventional automobile floor mat, and skid-proof bosses are more precisely formed on the bottom of the automobile floor mat than those of the conventional automobile floor mat.

To accomplish the above object of the present invention, there is provided an automobile floor mat comprising: a pad; skid-proof bosses which are integrally formed and protruded on the bottom of the pad made of a molding material, wherein the edges of the skid-proof bosses are sharply formed on the pad; and sill skirts each having a certain width and height formed along the edge of the pad, wherein the sill skirts are smoothly formed without having partitioning marks.

There is also provided an automobile floor mat which is manufactured with a floor mat manufacturing mold comprising: a lower mold which has a pad forming hole, boss forming holes, and sill skirt forming protrusions which are shaped in the upper portion thereof in correspondence to the pad, the bosses and the sill skirts of the mat, respectively; and an upper mold which is combined with the lower mold, to thus cover the pad forming hole, the sill skirt forming protrusions, and the boss forming holes, and has sill skirt forming grooves corresponding to the sill skirt forming protrusions of the lower mold on the bottom thereof, wherein the lower mold is separately formed into a base mold on which coupling grooves each having a certain depth are formed inwards from the sill skirt forming protrusions and a boss forming mold which are supported and combined with the coupling grooves of the base mold in which a number of the boss forming holes are penetrated and formed, wherein a number of coupling holes are formed in the boss forming mold and the base mold, respectively, so as to penetrate the bottom of the base mold, and wherein a number of coupling bolts are engaged into the coupling holes, respectively to thus integrally combine the boss forming mold and the base mold with each other to then form the lower mold.

Here, when a molding material is injected into the boss forming mold and the base mold formed in the lower mold, and then the molding material injected into the lower mold is heated with a high temperature and pressurized with a high pressure at the same time of combining the lower mold with the upper mold, air remaining in not only the pad forming hole and the boss forming holes which are positioned between the upper mold and the lower mold but also air remaining between the sill skirt forming protrusions and the sill skirt forming grooves, and gas generated from the molding material is discharged out through a coupling surface formed between the boss forming mold and the base mold and a coupling surface formed between the respective coupling holes and the respective coupling bolts, whereby the molding material is filled between the pad forming hole and the boss forming holes formed in the lower mold and between the sill skirt forming protrusions of the lower mold and the sill skirt forming grooves of the upper mold, to thus form the pad, the bosses and the smooth sill skirts of the mat.

There is still also provided an automobile floor mat manufacturing method which is executed with a floor mat manufacturing mold comprising: a lower mold which has a pad forming hole, boss forming holes, and sill skirt forming protrusions which are shaped in the upper portion thereof in correspondence to the pad, the bosses and the sill skirts of the mat, respectively; and an upper mold which is combined with the lower mold, to thus cover the pad forming hole, the sill skirt forming protrusions, and the boss forming holes, and has sill skirt forming grooves corresponding to the sill skirt forming protrusions of the lower mold on the bottom thereof, wherein the lower mold is separately formed into a base mold on which coupling grooves each having a certain depth are formed inwards from the sill skirt forming protrusions and a boss forming mold which are supported and combined with the coupling grooves of the base mold in which a number of the boss forming holes are penetrated and formed, wherein a number of coupling holes are formed in the boss forming mold and the base mold, respectively, so as to penetrate the bottom of the base mold, and wherein a number of coupling bolts are engaged into the coupling hole to thus integrally combine the boss forming mold and the base mold with each other to then form the lower mold, the automobile floor mat manufacturing method comprising the steps of: injecting a molding material into the boss forming mold and the base mold formed in the lower mold; heating the molding material injected into the lower mold with a high temperature and pressurizing the same with a high pressure at the same time of combining the lower mold with the upper mold; and discharging air remaining in not only the pad forming hole and the boss forming holes which are positioned between the upper mold and the lower mold but also air remaining between the sill skirt forming protrusions and the sill skirt forming grooves, and gas generated from the molding material, through a coupling surface formed between the boss forming mold and the base mold and a coupling surface formed between the respective coupling holes and the respective coupling bolts, whereby the molding material is filled between the pad forming hole and the boss forming holes formed in the lower mold and between the sill skirt forming protrusions of the lower mold and the sill skirt forming grooves of the upper mold, to thus form the pad, the bosses and the smooth sill skirts of the mat.

Preferably, gaps are formed between the coupling grooves of the base mold and the coupling surface of the boss forming mold, in a manner that a molding material injected into the boss forming holes and between the sill skirt forming protrusions and the sill skirt forming grooves, respectively does not pass through the gaps, and air or gas can be discharged out through the gaps.

Preferably, gaps are formed between the coupling holes formed in the base mold and the boss forming mold, and the coupling surfaces of the coupling bolts in a manner that a molding material injected into the boss forming holes and between the sill skirt forming protrusions and the sill skirt forming grooves, respectively does not pass through the gaps, and air or gas can be discharged out through the gaps.

Preferably, a stop sill groove through which a head of each coupling bolt is inserted and supported is formed in the lower end of each coupling hole formed in the base mold.

Preferably, each coupling hole of the boss forming mold is formed to perpendicularly penetrate the boss forming mold, in order to widen a coupling area of each coupling bolt engaged through each coupling hole of the lower mold.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a perspective view showing a conventional mat for use in an automobile;

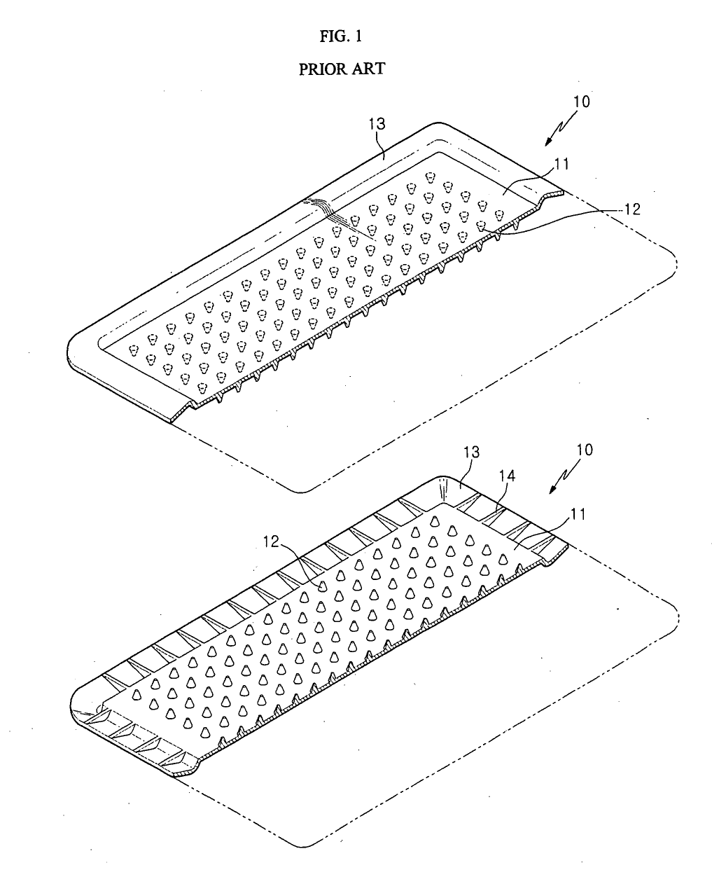

FIG. 2 is a cross-sectional view showing a conventional mold for making a mat for use in an automobile;

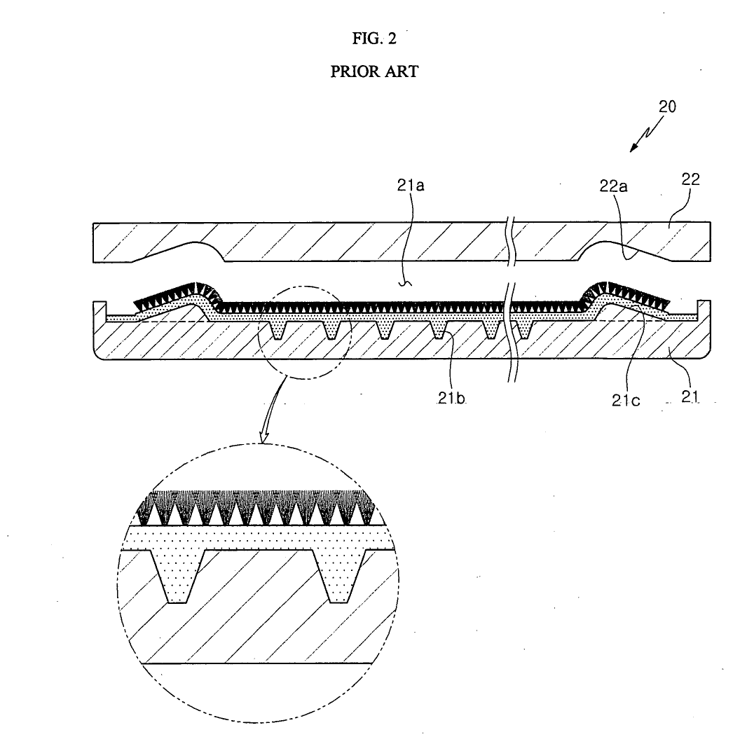

FIG. 3 is a perspective view partly showing a conventional mold for making a mat for use in an automobile;

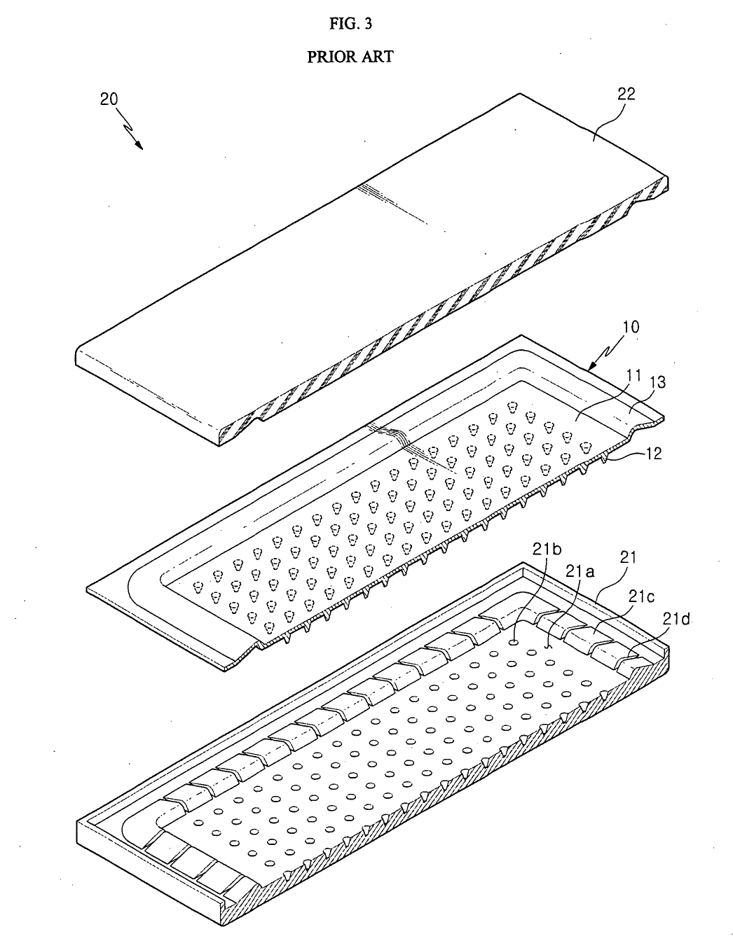

FIG. 4 is a perspective view showing a mat for use in an automobile according to an embodiment of the present invention;

FIG. 5 is a cross-sectional view showing a mold for making a mat for use in an automobile according to the present invention;

FIG. 6 is a perspective view partly showing an exploded state of a mold for making a mat for use in an automobile according to the present invention; and

FIG. 7 is a perspective view showing an assembled state of a mat for use in an automobile according to an embodiment of the present invention.

### DETAILED DESCRIPTION OF THE INVENTION

An automobile floor mat and a manufacturing method therefor according to a preferred embodiment of the present invention will be described with reference to the accompanying drawings.

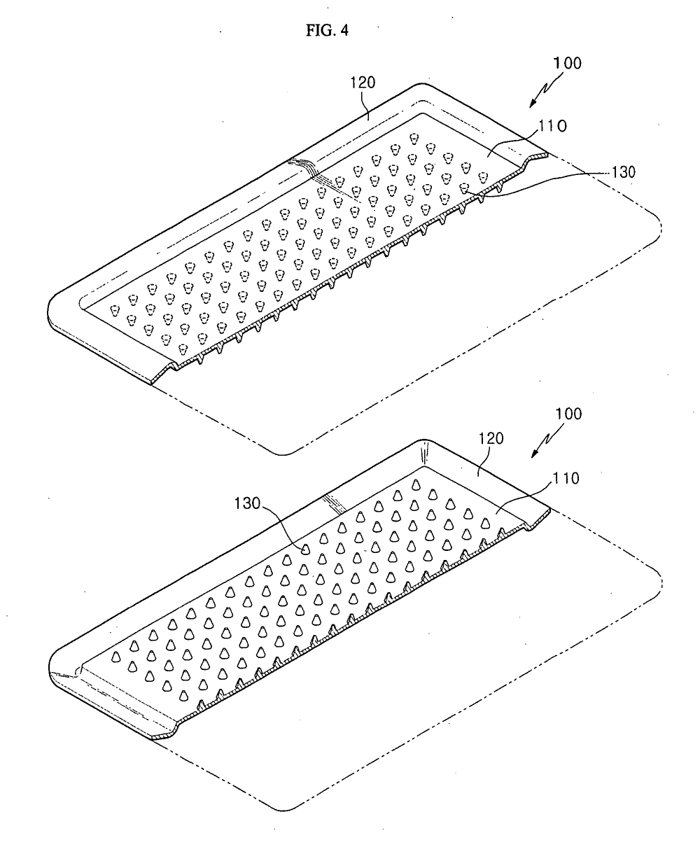

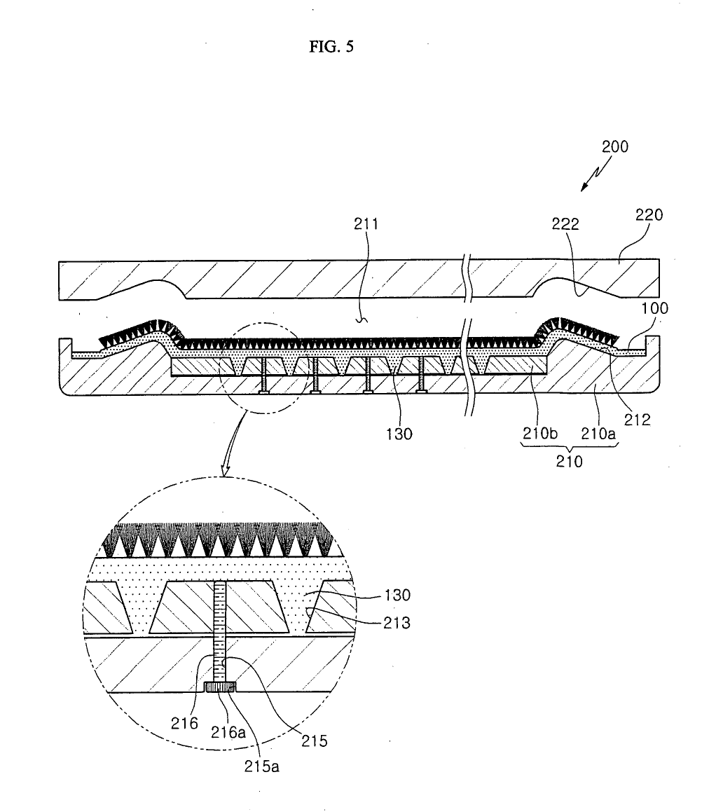

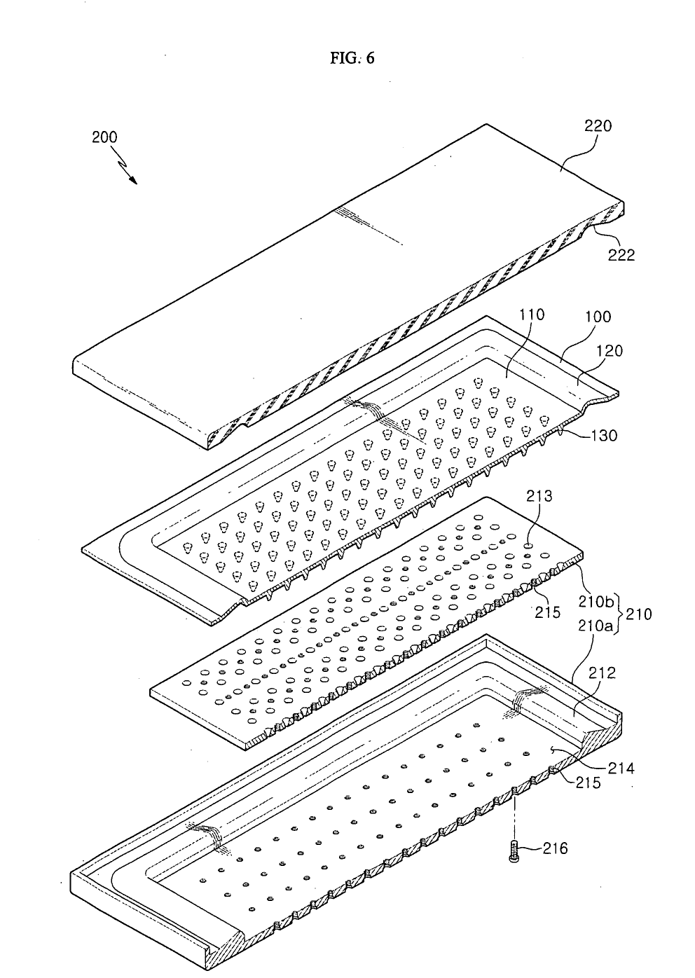

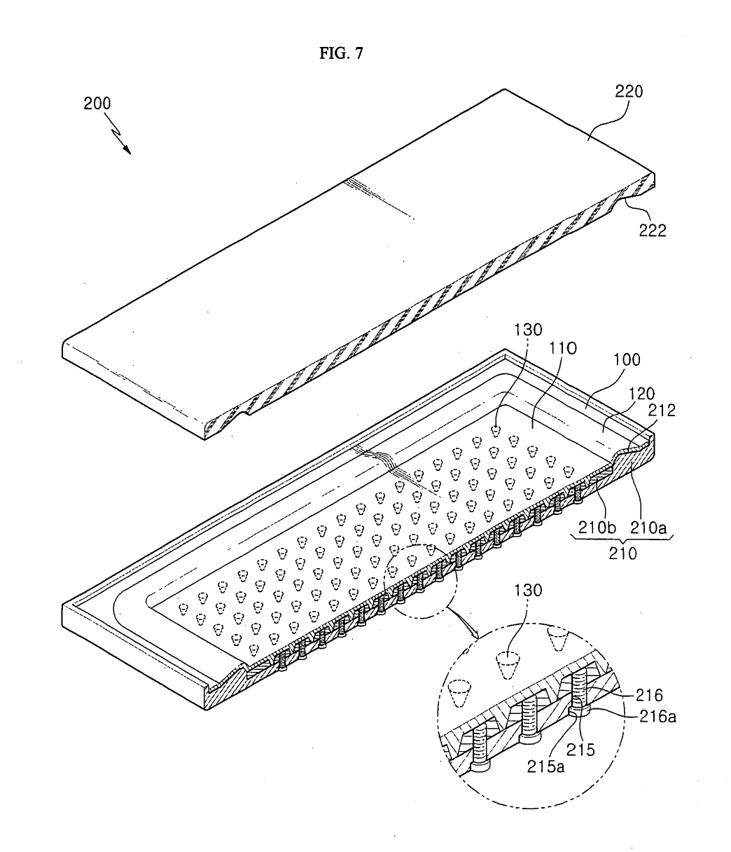

As shown in FIGS. 4 through 7, an automobile floor mat 100 according to the present invention is manufactured with an automobile floor mat manufacturing mold 200.

The floor mat manufacturing mold 200 includes a lower mold 210 which has a pad forming hole 211, boss forming holes 213, and sill skirt forming protrusions 212 which are shaped in the upper portion thereof in correspondence to the pad 110, the bosses 130 and the sill skirts 120 of the mat 100, respectively, and an upper mold 220 which is combined with the lower mold 210, to thus cover the pad forming hole 211, the sill skirt forming protrusions 212, and the boss forming holes 213, and has sill skirt forming grooves 222 corresponding to the sill skirt forming protrusions 212 of the lower mold 210 on the bottom thereof.

The lower mold 210 is separately formed into a base mold 210a on which coupling grooves 214 each having a certain depth are formed inwards from the sill skirt forming protrusions 212 and a boss forming mold 210b which are supported and combined with the coupling grooves 214 of the base mold 210a in which a number of the boss forming holes 213 are penetrated and formed.

A number of coupling holes 215 are formed in the boss forming mold 210b and the base mold 210a, respectively, so as to penetrate the bottom of the base mold 210a, and a number of coupling bolts 216 are engaged into the coupling holes 215, respectively to thus integrally combine the boss forming mold 210b and the base mold 210a with each other to then form the lower mold 210.

Here, when a molding material is injected into the boss forming mold 210b and the base mold 210a formed in the lower mold 210, and then the molding material injected into the lower mold 210 is heated with a high temperature and pressurized with a high pressure at the same time of combining the lower mold 210 with the upper mold 220, air remaining in not only the pad forming hole 211 and the boss forming holes 213 which are positioned between the upper mold 220 and the lower mold 210 but also air remaining between the sill skirt forming protrusions 212 and the sill skirt forming grooves 222, and gas generated from the molding material are discharged out through a coupling surface formed between the boss forming mold 210b and the base mold 210a and a coupling surface formed between the respective coupling holes 215 and the respective coupling bolts 216. Accordingly, the molding material is completely filled between the pad forming hole 211 and the boss forming holes 213 formed in the lower mold 210 and between the sill skirt forming protrusions 212 of the lower mold 210 and the sill skirt forming grooves 222 of the upper mold 220, to thus form the pad 110, the bosses 130 and the smooth sill skirts 120 of the mat 100.

The base mold 210a and the boss forming mold 210b are mutually combined with and detached from each other by the coupling bolts 216.

It is preferable that gaps are formed between the coupling grooves 214 of the base mold 210a and the coupling surface of the boss forming mold 210b, in a manner that a molding material injected into the boss forming holes 213 and between the sill skirt forming protrusions 212 and the sill skirt forming grooves 222, respectively does not pass through the gaps, and air or gas can be discharged out through the gaps.

It is also preferable that gaps are formed between the coupling holes 215 formed in the base mold 210a and the boss forming mold 210b, and the coupling surfaces of the coupling bolts 216 in a manner that a molding material injected into the boss forming holes 213 and between the sill skirt forming protrusions 212 and the sill skirt forming grooves 222, respectively does not pass through the gaps, and air or gas can be discharged out through the gaps.

It is also preferable that a stop sill groove 215a through which a head 216a of each coupling bolt 216 is inserted and supported is formed in the lower end of each coupling hole 215 formed in the base mold 210a, as being the case.

It is also preferable that each coupling hole 215 of the boss forming mold 210b is formed to perpendicularly penetrate the boss forming mold 210b, in order to widen a coupling area of each coupling bolt 216 engaged through each coupling hole 215 of the lower mold 210.

An automobile floor mat manufacturing method for manufacturing an automobile floor mat having the above-described structure according to the present invention will follow with reference to the accompanying drawings FIGS. 4 through 7.

As described above, an automobile floor mat 100 according to the present invention is manufactured with an automobile floor mat manufacturing mold 200. The floor mat manufacturing mold 200 includes a lower mold 210 and an upper mold 220.

The lower mold 210 includes a pad forming hole 211, boss forming holes 213, and sill skirt forming protrusions 212 which are shaped in the upper portion thereof in correspondence to the pad 110, the bosses 130 and the sill skirts 120 of the mat 100, respectively.

The upper mold 220 is combined with the lower mold 210, to thus cover the pad forming hole 211, the sill skirt forming protrusions 212, and the boss forming holes 213, and has sill skirt forming grooves 222 corresponding to the sill skirt forming protrusions 212 of the lower mold 210 on the bottom thereof.

The lower mold 210 is separately formed into a base mold 210a on which coupling grooves 214 each having a certain depth are formed inwards from the sill skirt forming protrusions 212 and a boss forming mold 210b which are supported and combined with the coupling grooves 214 of the base mold 210a in which a number of the boss forming holes 213 are penetrated and formed.

A number of coupling holes 215 are formed in the boss forming mold 210b and the base mold 210a, respectively, so as to penetrate the bottom of the base mold 210a, and a number of coupling bolts 216 are engaged into the coupling holes 215, respectively to thus integrally combine the boss forming mold 210b and the base mold 210awith each other to then form the lower mold 210.

A molding material is injected into the boss forming mold 210b and the base mold 210a formed in the lower mold 210. Then the molding material injected into the boss forming mold 210b and the base mold 210a formed in the lower mold 210 is heated with a high temperature and pressurized with a high pressure at the same time of combining the lower mold 210 with the upper mold 220.

Accordingly, the pressurized molding material is filled into the boss forming holes 213 of the boss forming mold 210b and between the sill skirt forming protrusions 212 of the lower mold 210 and the sill skirt forming grooves 222 of the upper mold 220. In this case, air remaining in not only the pad forming hole 211 and the boss forming holes 213 which are positioned between the upper mold 220 and the lower mold 210 but also air remaining between the sill skirt forming protrusions 212 and the sill skirt forming grooves 222, and gas generated from the molding material are pushed out by the filled molding material and discharged out through a coupling surface formed between the boss forming mold 210b and the base mold 210a and a coupling surface formed between the respective coupling holes 215 and the respective coupling bolts 216. Simultaneously, the molding material is completely filled and immediately cooled between the pad forming hole 211 and the boss forming holes 213 formed in the lower mold 210 and between the sill skirt forming protrusions 212 of the lower mold 210 and the sill skirt forming grooves 222 of the upper mold 220, to thus form the pad 110, the bosses 130 and the smooth sill skirts 120 of the mat 100. As a result, an automobile floor mat 100 is manufactured with the above-described automobile floor mat manufacturing method.

As described above, an automobile floor mat and manufacturing method therefor according to the present invention adopts a boss forming mold which is one element of a lower mold and a base mold which is another element of the lower mold. Accordingly, in the case that a molding material is filled into boss forming holes of the boss forming mold and between sill skirt forming protrusions of the lower mold and sill skirt forming grooves of an upper mold, air remaining in not only a pad forming hole and the boss forming holes but also air remaining between the sill skirt forming protrusions and the sill skirt forming grooves, and gas generated from the heated and pressurized molding material are pushed out by the filled molding material and discharged out through gaps formed between coupling grooves of the base mold which is one element of the lower mold and a coupling surface of the boss forming mold which is another element of the lower mold and gaps formed between respective coupling holes of the lower mold and of coupling surfaces of respective coupling bolts of the lower mold. Accordingly, the molding material is completely filled and immediately cooled between the pad forming hole and the boss forming holes formed in the lower mold and between the sill skirt forming protrusions and the sill skirt forming grooves, to thus form the pad, the bosses and the smooth sill skirts of the mat. As a result, the automobile floor mat manufacturing method according to the present invention has an effect of enhancing precision and reliability of the automobile floor mat manufactured using the same.

Also, the automobile floor mat according to the present invention has no partitioning marks which have been formed in sill skirts of the conventional automobile floor mat and have caused impedance of the beauty of the floor mat and unnecessary loss of the molding material. As a result, since the sill skirts are smoothly formed on the floor mat, the beauty and value of the floor mat can be enhanced.

As described above, the present invention has been described with respect to a particularly preferred embodiment. However, the present invention is not limited to the above embodiments, and it is possible for one who has an ordinary skill in the art to make various modifications and variations, without departing off the spirit of the present invention.

What is claimed is:

1. An automobile floor mat comprising:
a pad;
skid-proof bosses which are integrally formed and protruded on the bottom of the pad made of a molding material, wherein the edges of the skid-proof bosses are sharply formed on the pad; and
sill skirts each having a certain width and height formed along the edge of the pad, wherein the sill skirts are smoothly formed without having partitioning marks.

2. An automobile floor mat which is manufactured with a floor mat manufacturing mold comprising:
a lower mold which has a pad forming hole, boss forming holes, and sill skirt forming protrusions which are shaped in the upper portion thereof in correspondence to the pad, the bosses and the sill skirts of the mat, respectively; and
an upper mold which is combined with the lower mold, to thus cover the pad forming hole, the sill skirt forming protrusions, and the boss forming holes, and has sill skirt forming grooves corresponding to the sill skirt forming protrusions of the lower mold on the bottom thereof,
wherein the lower mold is separately formed into a base mold on which coupling grooves each having a certain depth are formed inwards from the sill skirt forming protrusions and a boss forming mold which are supported and combined with the coupling grooves of the base mold in which a number of the boss forming holes are penetrated and formed,
wherein a number of coupling holes are formed in the boss forming mold and the base mold, respectively, so as to penetrate the bottom of the base mold, and
wherein a number of coupling bolts are engaged into the coupling holes, respectively to thus integrally combine the boss forming mold and the base mold with each other to then form the lower mold.

3. The automobile floor mat according to claim 2, wherein gaps are formed between the coupling grooves of the base mold and the coupling surface of the boss forming mold, in a manner that a molding material injected into the boss forming holes and between the sill skirt forming protrusions and the sill skirt forming grooves, respectively does not pass through the gaps, and air or gas can be discharged out through the gaps.

4. The automobile floor mat according to claim 2, wherein gaps are formed between the coupling holes formed in the base mold and the boss forming mold, and the coupling surfaces of the coupling bolts in a manner that a molding material injected into the boss forming holes and between the sill skirt forming protrusions and the sill skirt forming grooves, respectively does not pass through the gaps, and air or gas can be discharged out through the gaps.

5. The automobile floor mat according to claim 2, wherein a stop sill groove through which a head of each coupling bolt is inserted and supported is formed in the lower end of each coupling hole formed in the base mold.

6. The automobile floor mat according to claim 2, wherein each coupling hole of the boss forming mold is formed to perpendicularly penetrate the boss forming mold, in order to widen a coupling area of each coupling bolt engaged through each coupling hole of the lower mold.

7. The automobile floor mat according to claim 2, wherein when a molding material is injected into the boss forming mold and the base mold formed in the lower mold, and then the molding material injected into the lower mold is heated with a high temperature and pressurized with a high pressure at the same time of combining the lower mold with the upper mold, air remaining in not only the pad forming hole and the boss forming holes which are positioned between the upper mold and the lower mold but also air remaining between the sill skirt forming protrusions and the sill skirt forming grooves, and gas generated from the molding material is discharged out through a coupling surface formed between the boss forming mold and the base mold and a coupling surface formed between the respective coupling holes and the respective coupling bolts, whereby the molding material is filled between the pad forming hole and the boss forming holes formed in the lower mold and between the sill skirt forming protrusions of the lower mold and the sill skirt forming grooves of the upper mold, to thus form the pad, the bosses and the smooth sill skirts of the mat.

8. An automobile floor mat manufacturing method which is executed with a floor mat manufacturing mold comprising: a lower mold which has a pad forming hole, boss forming holes, and sill skirt forming protrusions which are shaped in the upper portion thereof in correspondence to the pad, the bosses and the sill skirts of the mat, respectively; and an upper mold which is combined with the lower mold, to thus cover the pad forming hole, the sill skirt forming protrusions, and the boss forming holes, and has sill skirt forming grooves corresponding to the sill skirt forming protrusions of the lower mold on the bottom thereof, wherein the lower mold is separately formed into a base mold on which coupling grooves each having a certain depth are formed inwards from the sill skirt forming protrusions and a boss forming mold which are supported and combined with the coupling grooves of the base mold in which a number of the boss forming holes are penetrated and formed, wherein a number of coupling holes are formed in the boss forming mold and the base mold, respectively, so as to penetrate the bottom of the base mold, and wherein a number of coupling bolts are engaged into the coupling hole to thus integrally combine the boss forming mold and the base mold with each other to then form the lower mold, the automobile floor mat manufacturing method comprising the steps of:
injecting a molding material into the boss forming mold and the base mold formed in the lower mold;
heating the molding material injected into the lower mold with a high temperature and pressurizing the same with a high pressure at the same time of combining the lower mold with the upper mold; and
discharging air remaining in not only the pad forming hole and the boss forming holes which are positioned between the upper mold and the lower mold but also air remaining between the sill skirt forming protrusions and the sill skirt forming grooves, and gas generated from the molding material, through a coupling surface formed between the boss forming mold and the base mold and a coupling surface formed between the respective coupling holes and the respective coupling bolts,
whereby the molding material is filled between the pad forming hole and the boss forming holes formed in the lower mold and between the sill skirt forming protrusions of the lower mold and the sill skirt forming grooves of the upper mold, to thus form the pad, the bosses and the smooth sill skirts of the mat.

9. The automobile floor mat manufacturing method according to claim 8, wherein gaps are formed between the coupling grooves of the base mold and the coupling surface of the boss forming mold, in a manner that a molding material injected into the boss forming holes and between the sill skirt forming protrusions and the sill skirt forming grooves, respectively does not pass through the gaps, and air or gas can be discharged out through the gaps.

10. The automobile floor mat manufacturing method according to claim 8, wherein gaps are formed between the coupling holes formed in the base mold and the boss forming mold, and the coupling surfaces of the coupling bolts in a manner that a molding material injected into the boss forming holes and between the sill skirt forming protrusions and the sill skirt forming grooves, respectively does not pass through the gaps, and air or gas can be discharged out through the gaps.

11. The automobile floor mat manufacturing method according to claim 8, wherein a stop sill groove through which a head of each coupling bolt is inserted and supported is formed in the lower end of each coupling hole formed in the base mold.

12. The automobile floor mat manufacturing method according to claim 8, wherein each coupling hole of the boss forming mold is formed to perpendicularly penetrate the boss forming mold, in order to widen a coupling area of each coupling bolt engaged through each coupling hole of the lower mold.
